(19) United States
(12) Patent Application Publication
(10) Pub. No.: US 2017/0106459 A1
(43) Pub. Date: Apr. 20, 2017

(54) CUTTING TOOL FOR CUTTING FLAT MATERIALS

(71) Applicant: VOESTALPINE PRECISION STRIP GMBH, Boehlerwerk (AT)

(72) Inventor: Anton HAAS, Ardagger Stift (AT)

(73) Assignee: VOESTALPINE PRECISION STRIP GMBH, Boehlerwerk (AT)

(21) Appl. No.: 15/283,857

(22) Filed: Oct. 3, 2016

(30) Foreign Application Priority Data
Oct. 14, 2015 (AT) A50873/2015

(51) Int. Cl. B23D 61/12; B26D 1/00

(52) U.S. Cl. CPC B23D 61/121; B26D 1/0006; B26D 2001/0053; B26D 2001/0013

(57) ABSTRACT

Cutting tool for flat materials. The cutting tools includes a band-shaped base body which has on one longitudinal side a working region with cutting teeth and on an other longitudinal side a supporting region with a supporting surface. The cutting teeth are formed with tips and include cutting sides emanating from the tips at an angle a to one another. In a longitudinal direction of the working region, the tips of adjacent cutting teeth have different distances to the supporting surface.

### CROSS-REFERENCE TO RELATED APPLICATIONS

The present application claims priority under 35 U.S.C. §119 of Austrian Patent Application No. A50873/2015, filed Oct. 14, 2015, the disclosure of which is expressly incorporated by reference herein in its entirety.

### BACKGROUND

1. Field of the Invention

The invention relates to a cutting tool made of hardenable steel for cutting flat materials, for example cardboard, corrugated cardboard, honeycomb packaging, plastic panels and the like, comprising a band-shaped base body which has in a longitudinal direction on one side a working region with cutting teeth and on the other side a supporting region with a supporting surface, possibly with a plurality of supporting surfaces.

2. Discussion of Background Information

Flat materials made of pliable material with high local loading constitute a suitable packaging for delivering goods to customers or businesses.

Selected packaging materials such as cardboard, corrugated cardboard, honeycomb packaging, plastic panels and the like typically ensure an intact transport even of brittle, bulky goods.

For a shipping of identically shaped and uniform goods, the typically foldable shapes of packaging blanks are punched out from panels or planes of the respective flat material, which packaging blanks can easily be shaped into containers.

A punching of these packaging blanks from the flat material occurs via flatbed or rotary punching devices that are equipped with cutting tools.

Cutting tools, which are also referred to in the technical terminology as cutting rules or punching lines, consistently have a band-shaped base body and comprise in the longitudinal direction thereof a cutting working region on one side and a supporting region on the other side.

The working region or cutting edge is typically embodied with teeth in order to achieve an easy penetration by the cutting tool through the item being punched with a formation of cut surfaces which are desirably undeformed.

Embodiments of the cutting edge of the tool with teeth, which can have hardened cutting edges, are known and are used advantageously.

In the case of new types of flat materials with certain mechanical property profiles such as improved impact absorption, higher buckling stability and the like, and with the increased use of recycled materials in the production of the same, the tooth tips usually deform the surface layer when the cut is created before penetration of the flat material. A local indentation and deformations due to a hard and/or pliable surface of flat materials thus in most cases causes a rough, uneven cut surface.

Such uneven cut surfaces of a punched packaging blank can be detrimental to the appearance of a packaging unit and impede a mechanical placement of goods into the packaging.

### SUMAMARY

Embodiments of the invention overcome the disadvantages of the existing cutting blades and create a cutting tool of the type named at the outset which in a cutting through of flat material by way of punching prevents a formation of deformed cut regions and creates even cut surfaces over the cross-section.

Furthermore, embodiments of the invention minimize the penetration depths of the tips of the cutting tool in the pliable support of the flat material.

These embodiments are attained in that the cutting teeth are formed with tips having radii up to 2.0 mm and, emanating therefrom, cutting sides with an angle α of 60° to 90° to one another, wherein in a longitudinal direction of the cutting tool adjacent cutting teeth have a different distance from the cutting tips to the opposing supporting surface(s).

An embodiment according to the invention of the working region of a cutting tool is such that the furthest protruding tips of the cutting teeth, each having a given distance to the opposing supporting surface, have a large distance to one another. In this way, a local pressure loading of the surface of the flat material is widely spaced when the cut begins to be created. When the tool is activated, the local resistance of the flat material to pressure deformation in the region of the tooth tips is thus high, which results in an easier penetration by the tooth tips and an advancement of the cut via the sharp-edged cutting sides of the tool with a low loading of the surface region of the flat material.

Adjacent tooth tips having a smaller distance to the opposing supporting surface compared to the protruding tooth tips are likewise widely spaced in a longitudinal direction of the tool, which promotes a penetration by the tooth tips of the surface of the flat material as a result of a high local resistance without lasting deformation.

A varying distance of adjacent cutting teeth of a cutting tool according to the invention to an opposing supporting surface is essential, and a respective radius of the tooth tips of less than 2 mm as well as an angle α of 60° to 90° of the cutting sides to one another are material to a desired even cut-surface formation during a punching of a packaging blank from a flat material.

In one embodiment of a cutting tool according to the invention, three adjacent cutting tooth tips each can also be provided respectively with a different distance to the opposing supporting surfaces, whereby additional advantages with regard to a cut creation and formation of the same occur.

In another embodiment, which minimizes penetration depth of spaced, furthest protruding tooth tips of the tool into the support of the flat material during cutting, the working region of a cutting tool includes adjacent tooth tips with a different distance to the opposing supporting surface.

If the cutting teeth comprise tips with a radius of 1 mm or less, but at least 0.1 mm, a penetration by the same of the surface of the flat material is advantageously facilitated and wear of the tooth tips during the punching operation is kept low.

Advantageously, the difference in the distances from the cutting tips of adjacent cutting teeth to the opposing supporting surface(s) is 0.5 mm to 2.0 mm, as the developments in the area of the properties of flat materials can thus be taken into account.

With regard to a stability of the flat material during a cut creation or a punching, it has proven advantageous if the cutting sides of the teeth respectively have an identical angle α of 65° to 75° to one another.

If the cutting sides advantageously have a cutting angle β of 40° to 55° in cross-section, an optimum can be attained in terms of a low cutting pressure during a cutting of flat material and in terms of low cutting edge wear.

Cutting edge wear can be further reduced if the cutting side regions have a hardness greater than 360 HB or 380 HV up to a depth of 0.5 mm.

In the cutting tool according to the invention, the working region with the cutting teeth can advantageously have a wear-resistant and/or a friction-reducing surface layer.

Embodiments are directed to a cutting tool for flat materials that includes a band-shaped base body which has on one longitudinal side a working region with cutting teeth and on an other longitudinal side a supporting region with a supporting surface. The cutting teeth are formed with tips and include cutting sides emanating from the tips at an angle α to one another, and in a longitudinal direction of the working region, the tips of adjacent cutting teeth have different distances to the supporting surface.

According to embodiments, the cutting tool can be formed from hardenable steel and the flat materials comprising cardboard, corrugated cardboard, honeycomb packaging, plastic panels.

In accordance with other embodiments, the supporting surface may include a plurality of supporting surfaces.

In other embodiments, the tips have radii up to 2.0 mm and the angle α is 60° to 90°. Further, the cutting teeth can include tips having a radius of 1 mm or less.

According to still other embodiments, the different distances can be 0.5 to 2.0 mm.

In accordance with other embodiments, the cutting sides of the teeth may have a same angle α of 65° to 75°.

In embodiments, the cutting sides may have a cutting angle β of 40° to 55° in cross-section.

In still other embodiments, the cutting sides can have a hardness greater than 360 HB or 380 HV up to a depth of 0.5 mm.

Moreover, the working region with the cutting teeth may have at least one of a wear-resistant and/or friction-reducing surface layer.

Embodiments of the invention are directed to a cutting tool for cutting a flat material that includes a band-shaped base body having an upper and a lower longitudinal extent, a height extending between the upper and lower longitudinal extent, and a thickness perpendicular to the height and the upper and lower longitudinal extents; and a working region having a plurality of teeth formed along the upper longitudinal extent and a supporting region formed along the lower longitudinal extent. The plurality of teeth have tooth tips and cutting sides extending from respective tooth tips at an angle α to one another, and wherein the tooth tips of successive teeth in the working region are located at different distances from the support surface.

According to embodiments, a first tooth tip of a first of the successive teeth in the working region can be located at a first distance from the support surface and a second tooth tip of a second of the successive teeth in the working region, which is adjacent the first of the successive teeth, can be located at a second distance from the support surface, the second distance being less than the first distance. Further, a tooth trough may be formed between adjacent teeth where facing cutting surfaces of the adjacent teeth meet, and for each of the successive teeth in the working region, the tooth troughs can be located at a same distance from the support surface.

In further embodiments, a first tooth tip of a first of the successive teeth in the working region may be located at a first distance from the support surface, a second tooth tip of a second of the successive teeth in the working region, which is adjacent the first of the successive teeth, may be located at a second distance from the support surface, and a third tooth tip of a third of the successive teeth, which is adjacent the second of the successive teeth, may be located at a third distance from the support surface. The third distance is less than the first distance and the second distance is less than the third distance.

According to still other embodiments, a first tooth tip of a first of the successive teeth in the working region can be located at a first distance from the support surface, a second tooth tip of a second of the successive teeth in the working region, which is adjacent the first of the successive teeth, can be located at a second distance from the support surface, a third tooth tip of a third of the successive teeth, which is adjacent the second of the successive teeth, can be located at a third distance from the support surface, and a fourth tooth tip of a fourth of the successive teeth, which is adjacent the fourth of the successive teeth, can be located at a fourth distance from the support surface. The third distance is less than the first distance, the second distance is less than the third distance, and the fourth distance is the same as the second distance.

According to still other embodiments, a first tooth tip of a first of the successive teeth in the working region may be located at a first distance from the support surface, a second tooth tip of a second of the successive teeth in the working region, which is adjacent the first of the successive teeth, may be located at a second distance from the support surface, a third tooth tip of a third of the successive teeth, which is adjacent the second of the successive teeth, may be located at a third distance from the support surface, a fourth tooth tip of a fourth of the successive teeth, which is adjacent the fourth of the successive teeth, may be located at a fourth distance from the support surface, and a fifth tooth tip of a fifth of the successive teeth, which is adjacent the fifth of the successive teeth, may be located at a fifth distance from the support surface. The third distance is less than the first distance, the second distance is less than the third distance, the fourth distance is the same as the second distance, and the fifth distance is the same as the first distance.

In accordance with other embodiments, the tooth tips may have radii up to 2.0 mm. Further, the tooth tips can have radii 1 mm or less.

According to further embodiments, a tooth trough may be formed between adjacent teeth where facing cutting surfaces of the adjacent teeth meet, and for each of the successive teeth in the working region, the tooth troughs can be located at a same distance from the support surface.

In accordance with still yet other embodiments of the present invention, the plurality of teeth can have tooth tips and cutting sides extending from respective tooth tips in a direction of the thickness at an angle β to one another, and the tooth tips of successive teeth in the working region can be located at different distances from the support surface. The angle α can be 60° to 90° and the angle β can be 40° to 55°. Further, the angle α may be 65° to 75°.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a cutting tool according to the prior art;

FIG. 2 shows an embodiment of a cutting tool according to the invention for cutting flat materials;

FIG. 3 shows another embodiment of the cutting tool according to the invention; and

FIG. 4 shows a cross-sectional view of the cutting tool.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The following list of reference numerals is intended to provide easier association of the components of the cutting tool according to the invention:
S Cutting tool
1, 1′, 1″ Working region
11, 11′, 11″ Cutting teeth
111, 111″, 111″ Tips of the cutting teeth
112, 112′, 112″ Cutting sides
α Angle of opposing cutting sides in longitudinal direction
β Angle of opposing cutting sides in thickness direction
2, 2′, 2″ Supporting region
22, 22′ Supporting surface(s)
A, A′, A″ Distance of the cutting tooth tips to the supporting surface
B, B′, B″ Tooth length between the furthest protruding tooth tips and the tooth base

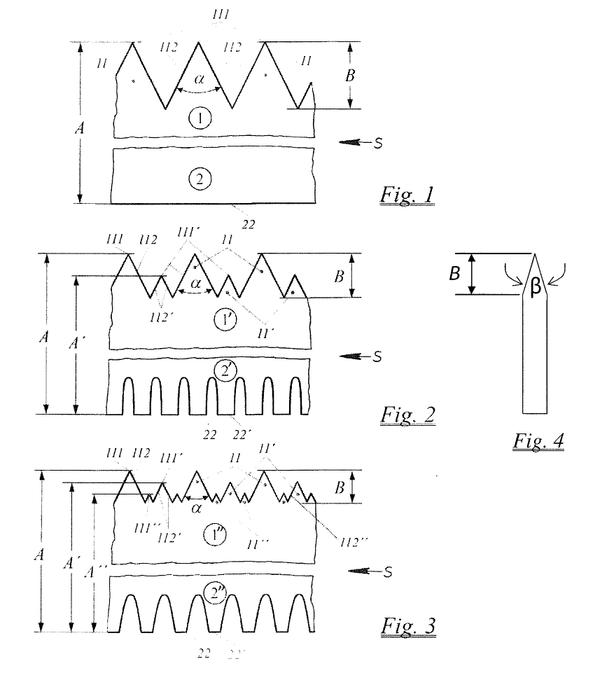

FIG. 1 schematically illustrates an essentially known cutting tool S for cutting flat materials.

A band-shaped base body comprises a working region 1 with teeth 11, wherein cutting sides 112 emanate from the tooth tips 111. Flanks of tooth tips 11 have or form an angle α to one another.

A supporting region 2 of the base body has a supporting surface 22, to which the tips 111 of the cutting teeth 11 have an identical distance A.

A given tooth shape with a defined spacing of the teeth 11 in a longitudinal direction results in a maximum tooth length B between the tooth tips 111 and the tooth base.

During a punching of a flat material, the tips 111 of the teeth 11 of the tool S penetrate a flexible, pliable support of the flat material at least over a distance with the dimension B.

In FIG. 2, an embodiment of a cutting tool S according to the invention is illustrated schematically.

A cutting region 1′ of the band-shaped base body has a tooth 11′ arranged in a longitudinal region between successive furthest protruding teeth 11, which have tooth tips 111 that protrude a distance A from supporting surface 22. Cutting sides 112 of successive teeth 11 are adjacent cutting sides 112′ of tooth 11′, which has a tooth tip 111′ that protrudes a smaller distance A′ from supporting surface 22 and, thus, is recessed. The cutting sides 112 and 112′ meet at a tooth base or trough.

When cutting tool S is lowered onto the flat material, or in a relative movement of this type, protruding tooth tips 111 having a large distance A from supporting surface 22, 22′ first penetrate the flat material, after which a cut is created via cutting sides 112 with low loading of the flat material until contact is made with adjacent recessed cutting tips 111′ of cutting teeth 11′.

However, tips 111′ of cutting teeth 11′ that have smaller distance A′ to supporting surface 22, 22′ are also spaced from one another and penetrate the flat material without lasting deformation, and complete the cutting of the material via cutting sides 112′.

As shown in FIG. 2, cutting sides 112 extend from tips 111 at an angle a to each other. By way of non-limiting example, angle α can be 60° to 90°, and preferably 65° to 75°. Further, cutting sides 112′ can extend from tips 111′ at angle, and preferably at angle α.

With cutting blade S according to the invention, not only can an even cut of the flat material be achieved, the extent of the penetration by tooth tips 111 of cutting tool S into the support of a flat material is reduced to a dimension B, which results in an increase of the resilience of the substrate in the punching operation.

Dimension B is derived from the largest distance of the furthest protruding tooth tips 111 over the tooth base.

As can be seen from FIG. 3, further recessed teeth 11″ can be arranged in working region 1″ between furthest protruding teeth 11 and recessed teeth 11′ in a further embodiment of a punching tool S according to the invention.

All of the advantages notwithstanding, a penetration depth B of protruding teeth 11 into a support of a flat material is further reduced in such an embodiment of the cutting teeth 11, 11′, 11″ in working region 1″.

FIG. 3 shows that cutting sides 112 extend from tips 111 at an angle a to each other. By way of non-limiting example, angle α can be 60° to 90°, and preferably 65° to 75°. Further, cutting sides 112′ can extend from tips 111′ at an angle to each other, preferably at angle α, and cutting sides 112″can extend from tips 111″ at an angle to each other, preferably angle α.

As shown in FIG. 4, tips 111, as well as tips 111′ (in the embodiment of FIG. 2) or tips 111′ and 111″ (in the embodiments of FIG. 3), can have, in the thickness direction, cutting sides extending from the respective tips at an angle β to each other. In embodiments, angle β can be 40° to 55°.

Cutting tools according to the invention have, particularly in rotary punching, significant advantages, including smooth machine operation, a reduced bending load on the teeth, high dimensional accuracy of the cuts and the like.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A cutting tool for flat materials, comprising:
a band-shaped base body which has on one longitudinal side a working region with cutting teeth and on an other longitudinal side a supporting region with a supporting surface,
wherein the cutting teeth are formed with tips and include cutting sides emanating from the tips at an angle α to one another,
wherein, in a longitudinal direction of the working region, the tips of adjacent cutting teeth have different distances to the supporting surface.

2. The cutting tool according to claim 1 being formed from hardenable steel and the flat materials comprising cardboard, corrugated cardboard, honeycomb packaging, plastic panels.

3. The cutting tool according to claim 1, wherein the supporting surface comprises a plurality of supporting surfaces.

4. The cutting tool according to claim 1, wherein the tips have radii up to 2.0 mm and the angle α is 60° to 90°.

5. The cutting tool according to claim 4, wherein the cutting teeth comprise tips having a radius of 1 mm or less.

6. The cutting tool according to claim 1, wherein the different distances are 0.5 to 2.0 mm.

7. The cutting tool according to claim 1, wherein the cutting sides of the teeth have a same angle α of 65° to 75°.

8. The cutting tool according to claim 1, wherein the cutting sides have a cutting angle β of 40° to 55° in cross-section.

9. The cutting tool according to claim 1, wherein the cutting sides have a hardness greater than 360 HB or 380 HV up to a depth of 0.5 mm.

10. The cutting tool according to claim 1, wherein the working region with the cutting teeth has at least one of a wear-resistant and/or friction-reducing surface layer.

11. A cutting tool for cutting a flat material, comprising:
a band-shaped base body having an upper and a lower longitudinal extent, a height extending between the upper and lower longitudinal extent, and a thickness perpendicular to the height and the upper and lower longitudinal extents; and
a working region having a plurality of teeth formed along the upper longitudinal extent and a supporting region formed along the lower longitudinal extent;
wherein the plurality of teeth have tooth tips and cutting sides extending from respective tooth tips at an angle α to one another, and wherein the tooth tips of successive teeth in the working region are located at different distances from the support surface.

12. The cutting tool according to claim 11, wherein a first tooth tip of a first of the successive teeth in the working region is located at a first distance from the support surface and a second tooth tip of a second of the successive teeth in the working region, which is adjacent the first of the successive teeth, is located at a second distance from the support surface, the second distance being less than the first distance.

13. The cutting tool according to claim 12, wherein a tooth trough is formed between adjacent teeth where facing cutting surfaces of the adjacent teeth meet, and
wherein, for each of the successive teeth in the working region, the tooth troughs are located at a same distance from the support surface.

14. The cutting tool according to claim 11, wherein a first tooth tip of a first of the successive teeth in the working region is located at a first distance from the support surface, a second tooth tip of a second of the successive teeth in the working region, which is adjacent the first of the successive teeth, is located at a second distance from the support surface, and a third tooth tip of a third of the successive teeth, which is adjacent the second of the successive teeth, is located at a third distance from the support surface, and
wherein the third distance is less than the first distance and the second distance is less than the third distance.

15. The cutting tool according to claim 11, wherein a first tooth tip of a first of the successive teeth in the working region is located at a first distance from the support surface, a second tooth tip of a second of the successive teeth in the working region, which is adjacent the first of the successive teeth, is located at a second distance from the support surface, a third tooth tip of a third of the successive teeth, which is adjacent the second of the successive teeth, is located at a third distance from the support surface, and a fourth tooth tip of a fourth of the successive teeth, which is adjacent the fourth of the successive teeth, is located at a fourth distance from the support surface, and
wherein the third distance is less than the first distance, the second distance is less than the third distance, and the fourth distance is the same as the second distance.

16. The cutting tool according to claim 11, wherein a first tooth tip of a first of the successive teeth in the working region is located at a first distance from the support surface, a second tooth tip of a second of the successive teeth in the working region, which is adjacent the first of the successive teeth, is located at a second distance from the support surface, a third tooth tip of a third of the successive teeth, which is adjacent the second of the successive teeth, is located at a third distance from the support surface, a fourth tooth tip of a fourth of the successive teeth, which is adjacent the fourth of the successive teeth, is located at a fourth distance from the support surface, and a fifth tooth tip of a fifth of the successive teeth, which is adjacent the fifth of the successive teeth, is located at a fifth distance from the support surface, and
wherein the third distance is less than the first distance, the second distance is less than the third distance, the fourth distance is the same as the second distance. and the fifth distance is the same as the first distance.

17. The cutting tool according to claim 11, wherein the tooth tips have radii up to 2.0 mm.

18. The cutting tool according to claim 17, wherein the tooth tips have radii 1 mm or less.

19. The cutting tool according to claim 11, wherein a tooth trough is formed between adjacent teeth where facing cutting surfaces of the adjacent teeth meet, and
wherein, for each of the successive teeth in the working region, the tooth troughs are located at a same distance from the support surface.

20. The cutting tool according to claim 11, wherein the plurality of teeth have tooth tips and cutting sides extending from respective tooth tips in a direction of the thickness at an angle β to one another, and wherein the tooth tips of successive teeth in the working region are located at different distances from the support surface, and
wherein the angle α is 60° to 90° and the angle β is 40° to 55°.
